(19) United States
(12) Patent Application Publication
(10) Pub. No.: US 2021/0277802 A1
(43) Pub. Date: Sep. 9, 2021

(54) FAN CASE FOR A GAS TURBINE ENGINE

(71) Applicant: General Electric Company, Schenectady, NY (US)

(72) Inventor: Ahamad Hussain Dudekula, Bengaluru (IN)

(21) Appl. No.: 17/193,787

(22) Filed: Mar. 5, 2021

(30) Foreign Application Priority Data
Mar. 7, 2020 (IN) 202011009890

(51) Int. Cl. F01D 25/24; F02K 3/06

(52) U.S. Cl. CPC F01D 25/24; F05D 2300/603; F05D 2220/36; F02K 3/06

(57) ABSTRACT

A fan case for a gas turbine engine including a first end, a second end, and an annular casing wall extending between the first end and the second end, the annular casing wall having a radially inner surface, a radially outer surface, and a thickness defined between the radially inner surface and the radially outer surface, and the annular casing wall also having diametrically-opposed first and second circumferential locations, wherein the thickness of the annular casing wall varies from a minimum thickness at the first circumferential location to a maximum thickness at the second circumferential location.

### CROSS-REFERENCE TO RELATED APPLICATION

The present application claims the benefit of priority to Indian Provisional Application No. 202011009890, filed on Mar. 7, 2020, entitled “FAN CASE FOR A GAS TURBINE ENGINE”, which is hereby incorporated by reference in its entirety for all purposes.

### FIELD OF THE DISCLOSURE

Certain examples pertain to fan casings, and, more particularly, to a fan case for a gas turbine engine such as a turbofan engine useful for aircraft propulsion.

### BACKGROUND

Gas turbine engines, in particular, turbofan engines utilized for aircraft propulsion, include a fan assembly having a plurality of fan blades extending radially outward from a fan disk which rotates about a central axis to generate thrust for aircraft propulsion. The fan assembly also typically includes an annular fan case having an annular casing wall which surrounds the fan blades and forms an outer wall bounding the fan duct. The fan case may also serve additional functions such as providing containment in the event any foreign object debris (FOD) or engine components such as fragments from a damaged fan blade may be driven radially outward by the rotating fan assembly. The fan case may also serve as an element of the engine mount system which affixes the gas turbine engine to the aircraft and carries structural loads.

The clearance between the radially inner surface of the fan case is an important factor in overall engine performance. While some clearance is necessary to prevent frictional contact between the ends of the rotating fan blades and the inner surface of the fan case, excessive clearance may result in a loss of engine performance and efficiency. Fan cases are typically constructed with a uniform circumferential thickness at each axial station along the annular casing wall, and are designed to circumferentially surround the rotating fan blades with a uniform clearance around their periphery. However, inlet loads and other loads imposed on the fan case during flight maneuvers may cause non-uniform distortions of the fan case, which in turn can lead to non-uniform clearances with respect to the periphery of the fan blades.

It would therefore be desirable to provide a fan case for turbofan gas turbine engines which addresses non-uniform loads which may be encountered during operating conditions.

### BRIEF DESCRIPTION

In one aspect, a fan case for a gas turbine engine includes a first end, a second end, and an annular casing wall extending between the first end and the second end, the annular casing wall having a radially inner surface, a radially outer surface, and a thickness defined between the radially inner surface and the radially outer surface, and the annular casing wall also having diametrically-opposed first and second circumferential locations, wherein the thickness of the annular casing wall varies from a minimum thickness at the first circumferential location to a maximum thickness at the second circumferential location.

In another aspect, a gas turbine engine includes a compressor, a combustor, a turbine, and a fan section having a fan with a plurality of fan blades and a fan case circumscribing and surrounding the fan blades, the fan case having a first end and a second end, and further including an annular casing wall extending between the first end and the second end, the annular casing wall having a radially inner surface, a radially outer surface, and a thickness defined between the radially inner surface and the radially outer surface, the annular casing wall also having diametrically-opposed first and second circumferential locations, wherein the thickness of the annular casing wall varies from a minimum thickness at the first circumferential location to a maximum thickness at the second circumferential location.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the presently described technology, including the best mode thereof, directed to one of ordinary skill in the art, is set forth in the specification, which makes reference to the appended Figures, in which:

FIG. 1 is a cross-sectional illustration of an exemplary gas turbine engine which includes a fan case as described herein.

FIG. 2 is an enlarged, partial cross-sectional illustration of an example fan case suitable for use in the gas turbine engine of FIG. 1, looking transverse to the longitudinal engine axis.

FIG. 3 is an enlarged, cross-sectional schematic illustration of an example fan case as described herein, looking axially aft.

FIG. 4 is a front view of an example fan case in which geometry of certain nodes has been modified.

Corresponding reference characters indicate corresponding parts throughout the several views. The exemplifications set out herein illustrate example embodiments of the disclosure, and such examples are not to be construed as limiting the scope of the disclosure in any manner.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

The following description is provided to enable those skilled in the art to make and use the described embodiments contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B is intended to refer to implementations including any of (1) at least one A, (2) at least one B, and (3) at least one A and at least one B.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present invention, and do not create limitations, particularly as to the position, orientation, or use of the invention. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Various aspects of the presently described technology are explained more fully with reference to the examples discussed below. It should be understood that, in general, the features of one embodiment also may be used in combination with features of another embodiment, and that the embodiments are not intended to limit the scope of the invention.

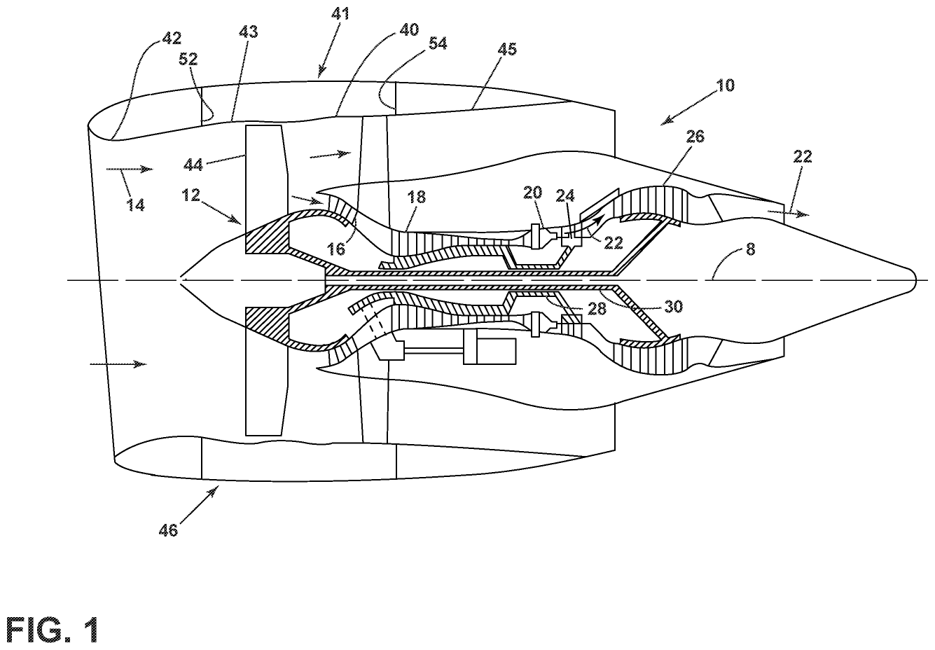

FIG. 1 is a cross-sectional schematic illustration of FIG. 1 is an example turbofan gas turbine engine 10 circumscribed about a centerline axis 8. The engine 10 includes, in downstream flow relationship, a fan 12 which receives ambient air 14, a low pressure or booster compressor (LPC) 16, a high pressure compressor (HPC) 18, a combustor 20 which mixes fuel with the air 14 pressurized by the HPC 18 for generating combustion gases 22 which flow downstream through a high pressure turbine (HPT) 24, and a low pressure turbine (LPT) 26 from which the combustion gases 22 are discharged from the engine 10. A first or high pressure (HP) shaft 28 joins the HPT 24 to the HPC 18, and a second or low pressure (LP) shaft 30 joins the LPT 26 to both the fan 12 and the low pressure compressor 16.

A fan section 46 of the engine 10 includes the fan 12 and a fan case 40 with a casing wall 43 circumscribing and surrounding fan blades 44 of the fan 12. The fan case 40 further included a fan duct 45 aft or downstream of and bolted to the fan case 40. The fan case 40, including casing wall 43, forms a containment system which circumscribes and surrounds the fan 12 and the fan blades 44 to retain any fan blades 44 or fan blade fragments dislodged from the engine fan 12. A “blade-out event” arises when a fan blade or portion thereof is accidentally released from a rotor of a high-bypass turbofan engine. When suddenly released during flight, a fan blade can impact a surrounding fan case with substantial force, and resulting loads on the fan case can cause circumferential cracking of the fan case. The fan case 40, and casing wall 43, may be of lightweight construction and be formed from metallic or non-metallic composite materials, and may be of unitary or layered construction incorporating various geometries and features for strength and containment.

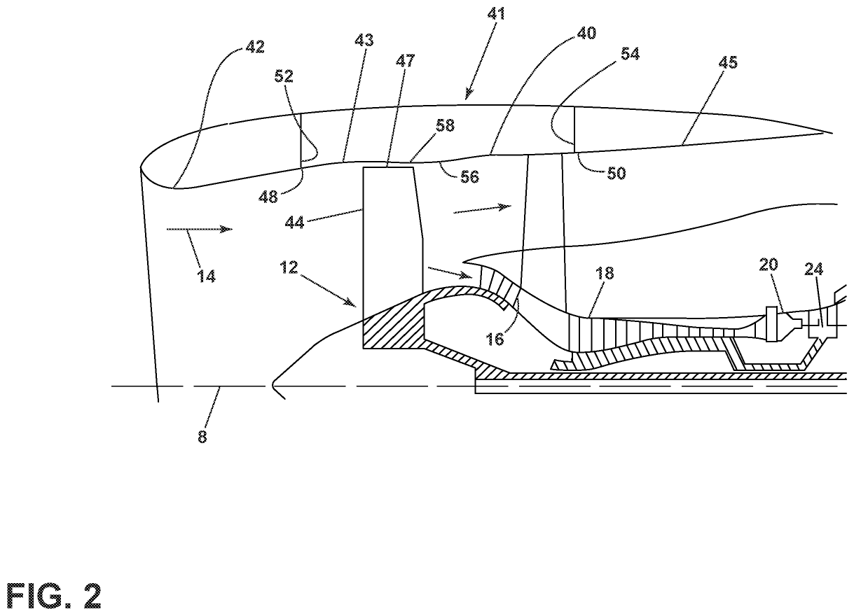

FIG. 2 is an enlarged, partial cross-sectional illustration of an example fan case 40 suitable for use in the gas turbine engine 10 of FIG. 1, looking transverse to the longitudinal engine axis 8.

As shown in FIG. 2, the fan case 42 extends axially aft from a first end 48 to a second end 50. The casing wall 43 of the fan case 40 is annular and extends from a forward flange 52 aft or downstream to an aft flange 54, such that the forward and aft flanges may be utilized to connect the fan case 40 to other structures such as the inlet 42 and fan duct 45. Flanges 52 and 54 may be utilized as bolted or bonded connections. Composite back sheets and fillers, such as honeycomb, may be utilized in conjunction with the casing wall 43 as part of a containment system. An annular layer of Kevlar may cover and surround an annular composite back sheet in the region surrounding the fan blades 44.

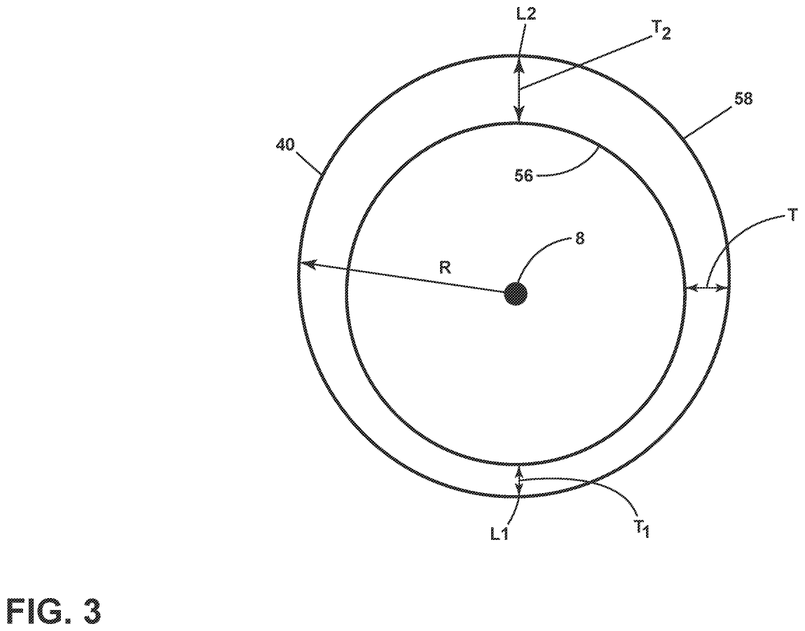

FIG. 3 is an enlarged, cross-sectional schematic illustration of an example fan case 40 as described herein, looking axially aft along the longitudinal engine axis 8.

As shown in FIG. 3, the thickness of the annular casing wall 43 varies from a first, minimum thickness T1 at a first location L1 to a second, maximum thickness T2 at a second location L2 which is diametrically opposite (180 degrees apart) from the first location L1. Typically, the second location L2 is at or near the vertically uppermost (i.e., 12 o'clock) portion of the fan case 40 when installed on the aircraft. The thickness T may vary in any suitable manner from minimum to maximum but may be designed to vary linearly, for example. The thickness may vary symmetrically in both circumferential directions from the first location L1 to the second location L2. The locations L1 and L2 are determined based on operating conditions anticipated in the flight envelope of the aircraft, including the normal gravitational loading of an aircraft operated predominantly in a normal horizontal flight regime. A varying radius R may be used to define the outer surface of the casing wall 43, while the interior radius is normally constant so as to maintain a constant clearance from the tips of the fan blades 44.

The variation in thickness T, defined between the inner surface 56 and the outer surface 58 of the casing wall 43, between T1 and T2 may be determined by a number of factors, such as the radius R, the axial length of the casing wall 43, the minimum thickness T1, the materials used to construct the casing wall 43 and their physical properties, the flight envelope of the aircraft, and other factors. The difference between T2 and T1 may be on the order of about 50% of T1. In one example, for a T1 thickness of about 1.7 inches and a radius R of about 70 inches, a difference between T2 and T1 of about 1.0 inches may be useful. For an aircraft operating in a predominantly 1 G (normal force of gravity) flight regime, such thickness variation in the casing wall 43 of the fan case 40 has been found to enhance the geometrical stability and uniformity of the inside radius R of the casing wall 43 and thereby maintain consistent clearances between the inner surface 56 of the casing wall and the tips 47 of the fan blades 44.

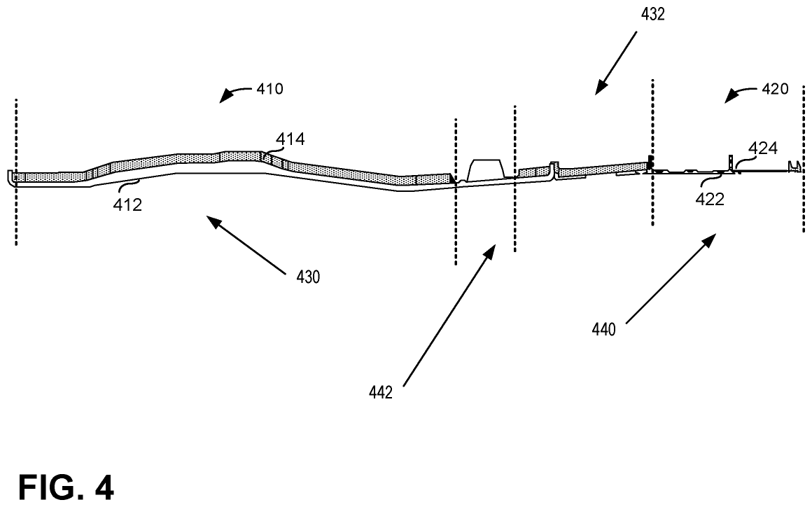

FIG. 4 is a front view showing outer nodes of the example fan case 40 in which geometry of certain nodes has been modified. The example fan case 40 includes a forward fan case 410 and an aft fan case 420. The forward fan case 410 includes an inner case profile 412 and an outer case profile 414. The aft fan case 420 also has an inner case profile 422 and an outer case profile 424. As shown in the example of FIG. 4, the inner case profile 422 and the outer case profile 424 are closely aligned. However, the outer case profile 414 is spaced apart from the inner case profile 412 of the forward fan case 410. As such, the inner profile 412, 422 of the fan case 40 does not change in either the forward portion 410 or the aft portion 420. The outer case profile 414, 424, however, decreases in thickness from the outer case profile 414 of the forward case 410 (having a maximum thickness for the fan case 40) to the outer case profile 424 of the after case 420 (having a minimum thickness for the fan case 40). As in the example of FIG. 3, the relationship between the inner surface 56, 412, 422 and the outer surface 58, 414, 424 of the fan casing 40 changes as the fan case 40 extends from front to back through the forward fan case portion 410 and the aft fan case portion 420. As noted in example of FIG. 4, modified regions 430, 432 exhibit a modified (e.g., thickened or expanded, etc.) geometry while unmodified regions 440, 442 have no change in geometry.

As such, certain examples geometrically modify fan case hardware to reduce non-symmetric fan distortions under different flight maneuver loads. In certain examples, rather than having a uniform thickness, an outer fan case is modified radially while, in at least a certain region, an inner profile of the fan case is not modified. For example, an initial fan case thickness ‘t’ inches is modified at a top of the case (e.g., near to mount location) to ‘(t+1) inch’ (e.g., a maximum value for the case) and at a bottom of the case to ‘t inch’ (e.g., a minimum value for the case). In between the top and bottom, case thickness varies linearly with respect to angle from the bottom to the top. Thus, fan case non-uniform circumferential thickness minimizes non-symmetry distortions under different maneuver inlet loads, which has a positive impact on specific fuel consumption (SFC) for the engine.

Using a fan case of non-uniform circumferential thickness removes higher-order non- symmetry distortions due to non-symmetry stiffness based on non-symmetry geometry, for example. The non-symmetric fan case has lower non-symmetry closures compared to a baseline design (e.g., comparing lift-off inlet loads, etc.). Under load conditions, such as a lift-off inlet load condition, etc., closure improvement and pocket clearance improvement are provided. SFC may also improve due to reduction or minimization of three-dimensional closures and pocket clearance area of the fan case.

All publications, patents and patent applications cited herein, whether supra or infra, are hereby incorporated by reference in their entirety to the same extent as if each individual publication, patent or patent application was specifically and individually indicated as incorporated by reference. It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material.

It must be noted that, as used in this specification and the appended claims, the singular forms “a,” “an” and “the” include plural referents unless the content clearly dictates otherwise.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, materials and methods according to some embodiments are described herein.

It should be noted that, when employed in the present disclosure, the terms “comprises,” “comprising,” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Various characteristics, aspects, and advantages of the present disclosure may also be embodied in any permutation of aspects of the disclosure, including but not limited to the following technical solutions as defined in the enumerated aspects:

1. A fan case for a gas turbine engine including a first end, a second end, and an annular casing wall extending between the first end and the second end, the annular casing wall having a radially inner surface, a radially outer surface, and a thickness defined between the radially inner surface and the radially outer surface, and the annular casing wall also having diametrically-opposed first and second circumferential locations, wherein the thickness of the annular casing wall varies from a minimum thickness at the first circumferential location to a maximum thickness at the second circumferential location.

2. The fan case of any preceding clause, wherein the second location is at a vertically uppermost portion of the fan case when installed on an aircraft.

3. The fan case of any preceding clause, wherein the thickness of the annular casing wall varies linearly from the minimum thickness to the maximum thickness.

4. The fan case of any preceding clause, wherein the thickness of the annular casing wall varies symmetrically in both circumferential directions from the first location to the second location.

5. The fan case of any preceding clause, wherein the annular casing wall has a constant internal radius and a varying external radius.

6. The fan case of any preceding clause, wherein the difference between the minimum thickness and the maximum thickness is about 50% of the minimum thickness.

7. The fan case of any preceding clause, wherein a difference between the minimum thickness and the maximum thickness is about 1 inch.

8. The fan case of any preceding clause, wherein the minimum thickness is about 1.7 inches, an internal radius of the casing wall is about 70 inches, and a difference between the minimum thickness and the maximum thickness is about 1 inch.

9. The fan case of any preceding clause, wherein the thickness of the annular casing wall varies symmetrically and linearly in both circumferential directions from the first location to the second location.

10. The fan case of any preceding clause, wherein the annular casing wall is a non-metallic composite material.

11. A gas turbine engine including a compressor, a combustor, a turbine, and a fan section having a fan with a plurality of fan blades and a fan case circumscribing and surrounding the fan blades, the fan case having a first end and a second end, and further including an annular casing wall extending between the first end and the second end, the annular casing wall having a radially inner surface, a radially outer surface, and a thickness defined between the radially inner surface and the radially outer surface, the annular casing wall also having diametrically-opposed first and second circumferential locations, wherein the thickness of the annular casing wall varies from a minimum thickness at the first circumferential location to a maximum thickness at the second circumferential location.

12. The gas turbine engine of any preceding clause, wherein the second location is at a vertically uppermost portion of the fan case when installed on an aircraft.

13. The gas turbine engine of any preceding clause, wherein the thickness of the annular casing wall varies linearly from the minimum thickness to the maximum thickness.

14. The gas turbine engine of any preceding clause, wherein the thickness of the annular casing wall varies symmetrically in both circumferential directions from the first location to the second location.

15. The gas turbine engine of any preceding clause, wherein the annular casing wall has a constant internal radius and a varying external radius.

16. The gas turbine engine of any preceding clause, wherein the difference between the minimum thickness and the maximum thickness is about 50% of the minimum thickness.

17. The gas turbine engine of any preceding clause, wherein a difference between the minimum thickness and the maximum thickness is about 1 inch.

18. The gas turbine engine of any preceding clause, wherein the minimum thickness is about 1.7 inches, an internal radius of the casing wall is about 70 inches, and a difference between the minimum thickness and the maximum thickness is about 1 inch.

19. The gas turbine engine of any preceding clause, wherein the thickness of the annular casing wall varies symmetrically and linearly in both circumferential directions from the first location to the second location.

20. The gas turbine engine of any preceding clause, wherein the annular casing wall is a non-metallic composite material.

While this disclosure has been described as having certain example embodiments, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A fan case for a gas turbine engine, the fan case comprising:
a first end, a second end, and an annular casing wall extending between the first end and the second end;
the annular casing wall having a radially inner surface, a radially outer surface, and a thickness defined between the radially inner surface and the radially outer surface; and
the annular casing wall also having diametrically-opposed first and second circumferential locations,
wherein the thickness of the annular casing wall varies from a minimum thickness at the first circumferential location to a maximum thickness at the second circumferential location.

2. The fan case of claim 1, wherein the second circumferential location is at a vertically uppermost portion of the fan case when installed on an aircraft.

3. The fan case of claim 1, wherein the thickness of the annular casing wall varies linearly from the minimum thickness to the maximum thickness.

4. The fan case of claim 1, wherein the thickness of the annular casing wall varies symmetrically in both circumferential directions from the first circumferential location to the second circumferential location.

5. The fan case of claim 1, wherein the annular casing wall has a constant internal radius and a varying external radius.

6. The fan case of claim 1, wherein a difference between the minimum thickness and the maximum thickness is about 50% of the minimum thickness.

7. The fan case of claim 1, wherein a difference between the minimum thickness and the maximum thickness is about 1 inch.

8. The fan case of claim 1, wherein the minimum thickness is about 1.7 inches, an internal radius of the annular casing wall is about 70 inches, and a difference between the minimum thickness and the maximum thickness is about 1 inch.

9. The fan case of claim 1, wherein the thickness of the annular casing wall varies symmetrically and linearly in both circumferential directions from the first circumferential location to the second circumferential location.

10. The fan case of claim 1, wherein the annular casing wall is a non-metallic composite material.

11. A gas turbine engine, comprising:
a compressor;
a combustor;
a turbine; and
a fan section having a fan with a plurality of fan blades and a fan case circumscribing and surrounding the fan blades, the fan case having a first end and a second end, and further comprising:
an annular casing wall extending between the first end and the second end,
the annular casing wall having a radially inner surface, a radially outer surface, and a thickness defined between the radially inner surface and the radially outer surface, and
the annular casing wall also having diametrically-opposed first and second circumferential locations,
wherein the thickness of the annular casing wall varies from a minimum thickness at the first circumferential location to a maximum thickness at the second circumferential location.

12. The gas turbine engine of claim 11, wherein the second circumferential location is at a vertically uppermost portion of the fan case when installed on an aircraft.

13. The gas turbine engine of claim 11, wherein the thickness of the annular casing wall varies linearly from the minimum thickness to the maximum thickness.

14. The gas turbine engine of claim 11, wherein the thickness of the annular casing wall varies symmetrically in both circumferential directions from the first circumferential location to the second circumferential location.

15. The gas turbine engine of claim 11, wherein the annular casing wall has a constant internal radius and a varying external radius.

16. The gas turbine engine of claim 11, wherein a difference between the minimum thickness and the maximum thickness is about 50% of the minimum thickness.

17. The gas turbine engine of claim 11, wherein a difference between the minimum thickness and the maximum thickness is about 1 inch.

18. The gas turbine engine of claim 11, wherein the minimum thickness is about 1.7 inches, an internal radius of the annular casing wall is about 70 inches, and a difference between the minimum thickness and the maximum thickness is about 1 inch.

19. The gas turbine engine of claim 11, wherein the thickness of the annular casing wall varies symmetrically and linearly in both circumferential directions from the first circumferential location to the second circumferential location.

20. The gas turbine engine of claim 11, wherein the annular casing wall is a non-metallic composite material.
